(19) United States
(12) Patent Application Publication
(10) Pub. No.: US 2024/0177266 A1
(43) Pub. Date: May 30, 2024

(54) IMAGE PROCESSING APPARATUS, IMAGE FORMING APPARATUS, IMAGE PROCESSING METHOD, AND STORAGE MEDIUM

(71) Applicant: CANON KABUSHIKI KAISHA, Tokyo (JP)

(72) Inventor: MASATARO SHIROIWA, Kanagawa (JP)

(21) Appl. No.: 18/509,525

(22) Filed: Nov. 15, 2023

(30) Foreign Application Priority Data
Nov. 29, 2022 (JP) 2022-189955

(51) Int. Cl. G06T 3/40; G06F 3/12

(52) U.S. Cl. CPC G06T 3/40; G06F 3/12

(57) ABSTRACT

An image placement unit obtains a blank area size in a main scanning direction available for nesting printing, from blank-area size information. The image placement unit refers to nesting-scaling-print setting information included in image data and calculates a maximum-reduction size and maximum-enlargement size to which reduction and enlargement are permitted. The image placement unit determines whether the maximum-reduction size and the maximum-enlargement size of an image are within the nesting blank area size. The image placement unit adjusts the size of the image by using a scaling processing unit and places the image in the nesting blank area. The image placement unit specifies the size after a placement position is determined to an image processing unit to generate image data of the image, and stores the generated image data into a storage apparatus. A blank-area measurement unit calculates the nesting blank area size after the image is placed.

### BACKGROUND

### Field

The present disclosure relates to an image processing technique for printing with a plurality of images arranged on a sheet.

### Description of the Related Art

Image forming apparatuses that temporarily store image data received from a host apparatus into an internal storage apparatus and read stored image data as appropriate for printing are known. Examples of image forming apparatuses of this type include a large-format printer that prints images based on image data on a large sheet such as roll paper to make posters or the like by printing. An image forming apparatus that performs printing on such a large sheet usually arranges a plurality of images in the sheet conveyance direction (the longitudinal direction, the sub scanning direction) for printing.

In a case in which roll paper having a width much larger than the width of an image is used, the area from the right end of the printed image to the right end of the sheet is sometimes not used for any printing, leading to waste of sheets. To address such a case, large format printers or the like have a function known as nesting printing in which data of a plurality of images is stored in a storage apparatus before printing, and these images are arranged in the main scanning direction (sheet width direction) orthogonal to the sheet conveyance direction to reduce waste of sheets.

In the case in which a plurality of images having different sizes are arranged in nesting printing, it is not so easy to know the overall size of the plurality of arranged images that some of the images arranged in the sheet width direction by the user may extend beyond the sheet width in some cases. In such a case, some images are rearranged in the sheet conveyance direction so that all of the images are within the sheet size, and printing is sometimes performed with a large blank area left in the width direction.

Japanese Patent Laid-Open No. 2011-48751 discloses a method in which the user specifies a plurality of areas into which roll paper is divided in the width direction, and the size of an image placed in each area is enlarged or reduced to be laid out so that the image fits each area in the width direction. In this method, the user adjusts the ratio of areas into which a sheet is divided in the width direction, instead of adjusting the size of each image, and the size of each image is automatically adjusted according to the size of each area where the image is placed. Thus, it is easy to adjust the images arranged in the width direction according to the width of the sheet.

However, Japanese Patent Laid-Open No. 2011-48751 has a problem in that since the sizes of the areas for arranging images are determined by the user, which means that the sizes of images are determined beforehand, if the size of an image does not fit the size of the area for the image to be placed in, the image cannot be placed or a useless blank space can remain.

With this, an object of the present disclosure is to improve sheet efficiency in printing with a plurality of images arranged on a sheet.

### SUMMARY

A present disclosure provides an image processing apparatus including: a generation unit that generates image data for printing in which a plurality of images included in a plurality of print jobs are arranged in a print area of a sheet; and a size adjustment unit that performs size adjustment on an image to be placed in the print area, in which in a case in which the generation unit generates the image data for printing in which the plurality of images are arranged in order in a specified direction, the size adjustment unit performs the size adjustment on an image to be placed such that the size of the image to be placed is within the size of a blank area located in the specified direction relative to an image placed immediately beforehand.

Further features of the present disclosure will become apparent from the following description of exemplary embodiments with reference to the attached drawings.

### BRIEF DESCRIPTION OF THE DRAWINGS

FIG. 1 is a diagram illustrating an example of the hardware configuration of an image forming apparatus according to an embodiment of the present disclosure;

FIG. 2 is a diagram illustrating an example of the software configuration implemented in a controller unit of the image forming apparatus according to the embodiment of the present disclosure;

FIG. 3A is a diagram illustrating a screen for setting nesting printing by the image forming apparatus according to the embodiment of the present disclosure and an example of a print page setting for image data for printing;

FIG. 3B is a diagram illustrating a screen for setting nesting printing by the image forming apparatus according to the embodiment of the present disclosure and an example of a print page setting for image data for printing;

FIG. 4 is a flowchart illustrating an example of image placement processing of the image forming apparatus according to the embodiment of the present disclosure;

FIG. 5 is a schematic diagram illustrating an example of an image to be printed by the image forming apparatus according to the embodiment of the present disclosure;

FIG. 6 is a schematic diagram illustrating an example of an area on a sheet on which an image to be printed by the image forming apparatus according to the embodiment of the present disclosure is placed;

FIG. 7A is a table illustrating an example of changes in a blank area size in nesting printing by the image forming apparatus according to the embodiment of the present disclosure;

FIG. 7B is a table illustrating an example of changes in a blank area size in nesting printing by the image forming apparatus according to the embodiment of the present disclosure;

FIG. 8 is a table illustrating an example of sizes specified in nesting-scaling-print setting information for each piece of image data in nesting printing by the image forming apparatus according to the embodiment of the present disclosure;

FIG. 9 is a schematic diagram illustrating an example of an image to be printed by the image forming apparatus according to the embodiment of the present disclosure;

FIG. 10 is a diagram illustrating an example of a print page setting for an image to be printed by the image forming apparatus according to the embodiment of the present disclosure;

FIG. 11 is a schematic diagram illustrating an example of data of images placed on a sheet used for printing by the image forming apparatus according to the embodiment of the present disclosure;

FIG. 12 is a diagram illustrating an example of a print page setting for image data to be printed by the image forming apparatus according to the embodiment of the present disclosure;

FIG. 13 is a schematic diagram illustrating an example of data of images placed on a sheet used for printing by the image forming apparatus according to the embodiment of the present disclosure;

FIG. 14 is a diagram illustrating an example of a print page setting for image data to be printed by the image forming apparatus according to the embodiment of the present disclosure;

FIG. 15 is a schematic diagram illustrating an example of data of images placed on a sheet used for printing by the image forming apparatus according to the embodiment of the present disclosure;

FIG. 16 is a diagram illustrating an example of a print page setting for image data to be printed by the image forming apparatus according to the embodiment of the present disclosure;

FIG. 17 is a schematic diagram illustrating an example of data of images placed on a sheet used for printing by the image forming apparatus according to the embodiment of the present disclosure;

FIG. 18 is a schematic diagram illustrating an example of image data to be printed by the image forming apparatus according to the embodiment of the present disclosure;

FIG. 19 is a diagram illustrating an example of a print page setting for image data to be printed by the image forming apparatus according to the embodiment of the present disclosure;

FIG. 20 is a schematic diagram illustrating an example of data of images placed on a sheet used for printing by the image forming apparatus according to the embodiment of the present disclosure;

FIG. 21 is a diagram illustrating an example of a print page setting for image data to be printed by the image forming apparatus according to the embodiment of the present disclosure;

FIG. 22 is a schematic diagram illustrating an example of data of images placed on a sheet used for printing by the image forming apparatus according to the embodiment of the present disclosure;

FIG. 23 is a diagram illustrating an example of a print page setting for image data to be printed by the image forming apparatus according to the embodiment of the present disclosure;

FIG. 24 is a schematic diagram illustrating an example of data of images placed on a sheet used for printing by the image forming apparatus according to the embodiment of the present disclosure;

FIG. 25 is a schematic diagram illustrating an example of image data to be printed by the image forming apparatus according to the embodiment of the present disclosure; and

FIG. 26 is a diagram illustrating an example of a print page setting for image data to be printed by the image forming apparatus according to the embodiment of the present disclosure.

### DESCRIPTION OF THE EMBODIMENTS

Hereinafter, an embodiment will be described in detail with reference to the attached drawings. The following embodiment is intended not to limit the disclosure according to the claims. Although the embodiment includes a plurality of features, all of the features are not essential for the disclosure, and any of the features may be combined in any manner. In the attached drawings, the same or similar constituents are denoted by the same reference numbers, and repetitive description thereof is omitted.

### (Apparatus Configuration)

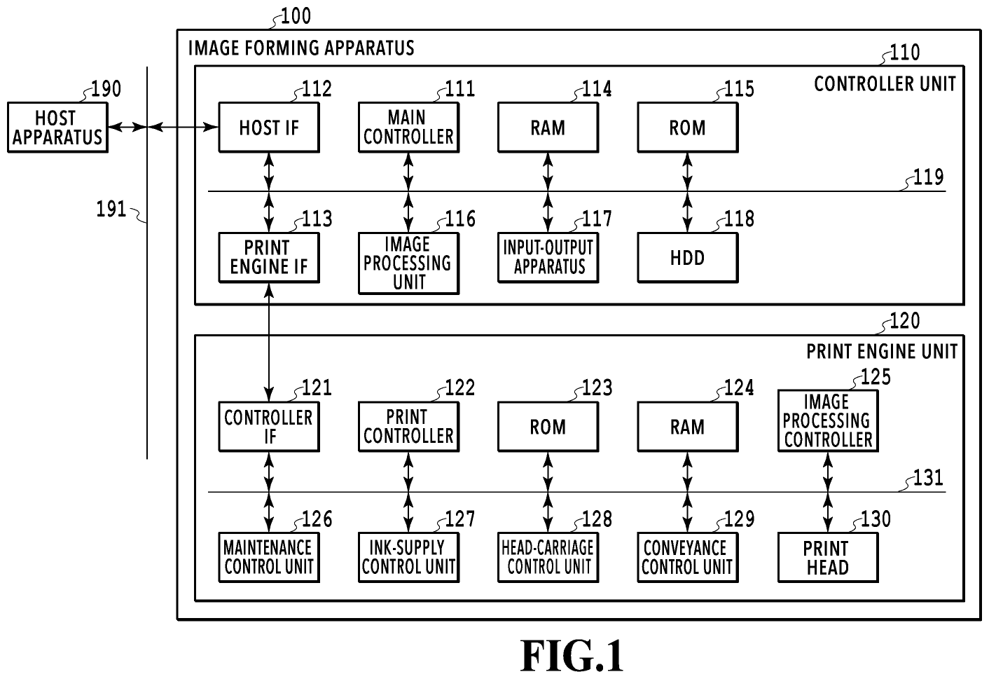

FIG. 1 is a diagram illustrating an example of the hardware configuration of an image forming apparatus according to the present embodiment. In FIG. 1, the image forming apparatus 100 includes a controller unit 110 and a print engine unit 120. The image forming apparatus 100 can be connected to a host apparatus 190 via a network 191.

The controller unit 110 includes a main controller 111, a host IF 112, a print engine IF 113, RAM 114, ROM 115, an image processing unit 116, an input-output apparatus 117, and a HDD 118. These are connected to one another via a system bus 119. The main controller 111 including a CPU performs print processing according to programs and various parameters stored in the ROM 115, using the RAM 114 as a work area, and controls the entire operation of the image forming apparatus 100. For example, in a case in which a print job including image data is inputted from the host apparatus 190 via the host IF 112, the image data included in the print job received by the image processing unit 116 is subjected to specified image processing according to instructions from the main controller 111. Then, the main controller 111 transmits the image data subjected to the image processing to the print engine unit 120 via the print engine IF 113.

The RAM 114 is used as a work area for the main controller 111 and as a temporary storage area for various kinds of reception data and also used for storing various kinds of setting data. The ROM 115 stores programs executed by the main controller 111 and various kinds of data necessary for various operations of the image forming apparatus 100.

The image processing unit 116 performs various kinds of image processing. For example, the image processing unit 116 develops (converts) image data expressed by a page description language into bitmap image data. For example, the image processing unit 116 converts the color space (for example, YCbCr) of inputted image data into a standard RGB color space (for example, sRGB). For example, the image processing unit 116 performs various kinds of image processing as necessary such as resolution conversion to an effective number of pixels (the number of pixels that the image forming apparatus 100 can handle in print processing), image analysis, image correction, and combining a plurality of pieces of image data to generate one piece of print image data. Image data obtained by these image processing operations is stored in the RAM 114.

The input-output apparatus 117 includes hardware keys or a panel for the user to perform various operations and a display unit for displaying various kinds of information (notification) to the user. To notify the user of information, the input-output apparatus 117 may output a sound (beep, voice, or the like) based on sound information from a sound generator.

The HDD 118 is a nonvolatile storage area and is capable of storing and reading programs executed by the main controller 111, image data, and setting information necessary for various operations of the image forming apparatus 100. Note that instead of the HDD 118, a mass storage apparatus of another type such as an SSD including flash memory may be used.

The print engine unit 120 is a printing unit configured to perform image formation. The print engine unit 120 includes a controller IF 121, a print controller 122, ROM 123, RAM 124, and an image processing controller 125. The print engine unit 120 further includes a maintenance control unit 126, an ink-supply control unit 127, a head-carriage control unit 128, a conveyance control unit 129, and a print head 130. These are connected to one another via a system bus 131.

The print controller 122 including a CPU controls various mechanisms included in the print engine unit 120 according to programs and various parameters stored in the ROM 123, using the RAM 124 as a work area. In a case in which the print engine unit 120 receives various commands and image data via the controller IF 121, the print controller 122 temporarily stores the commands and data into the RAM 124. The print controller 122 causes the image processing controller 125 to convert the stored print image data into print data so that the print head 130 can use the data for print operation. When print data is generated, the print controller 122 causes the print head 130 to execute print operation based on the print data. In this process, the print controller 122 requests the conveyance control unit 129 to convey a sheet. According to instructions from the print controller 122, the print head 130 executes print operation in conjunction with sheet conveyance operation, and print processing is thus performed.

The head-carriage control unit 128 changes the orientation and position of the print head 130 according to the operation state of the image forming apparatus 100 such as a maintenance state and a printing state. The ink-supply control unit 127 performs control such that the pressure of ink supplied to the print head 130 is within an appropriate range. The maintenance control unit 126 controls cleaning of conveyance rollers controlled by the conveyance control unit 129 and cleaning of the print head 130.

The print head 130 is a printing unit that performs image printing and is configured to print images in a print area on a sheet according to image data. The print head 130 includes, for example, a plurality of print head units corresponding to a plurality of colors and ejects ink in synchronization with sheet conveyance to form images on a sheet.

Although the input-output apparatus 117 is included in the image forming apparatus 100 in the present embodiment, the present disclosure is not limited to this configuration. For example, an input-output apparatus 117 may be an external apparatus connected via the network 191. Alternatively, the host apparatus 190 may also serve as an input-output apparatus 117. The image forming apparatus 100 may be configured to be connected not only to the input-output apparatus 117 but also to other input-output apparatuses via the network 191 or the like.

Although image data is temporarily stored in the RAM 114 and the RAM 124 in the present embodiment, image data may be temporarily stored in a nonvolatile device such as a HDD. The host apparatus 190 is, for example, an external apparatus serving as a supply source of image data and has a printer driver installed. The image forming apparatus 100 may be provided with a data supply apparatus serving as an image-data supply source such as a digital camera or a smartphone, for example, instead of the host apparatus 190.

The connection configuration between other apparatuses and the image forming apparatus 100 is not limited to one using the network 191. For example, other apparatuses and the image forming apparatus 100 may be directly connected to one another by wireless communication. Note that a program to provide functions of the present embodiment may be supplied to the system or apparatuses via a network or various storage media. A computer (CPU, MPU, or the like) of the system or the apparatuses may read the program to execute functions or may cause various mechanisms to execute the functions. This program may be executed by one computer or the cooperation of a plurality of computers. In addition, all of the foregoing processing does not have to be implemented by software. Part or all of the processing may be implemented by hardware such as an ASIC. Further, the present disclosure is not limited to configurations in which one CPU performs all of the processing. A configuration in which a plurality of CPUs work together as appropriate to perform the processing is possible, or a configuration in which one CPU executes part of the processing, and a plurality of CPUs work together to perform the rest of the processing is also possible.

The embodiment according to the present disclosure describes an example of nesting printing in which the image forming apparatus 100 performs printing with a plurality of images arranged in a print area on a sheet.

The following describes an example of a procedure of processing executed by the image forming apparatus 100 of the present disclosure with reference to drawings. In the present embodiment, the image forming apparatus 100 waits in a nesting print mode for a print job including image data from the host apparatus 190.

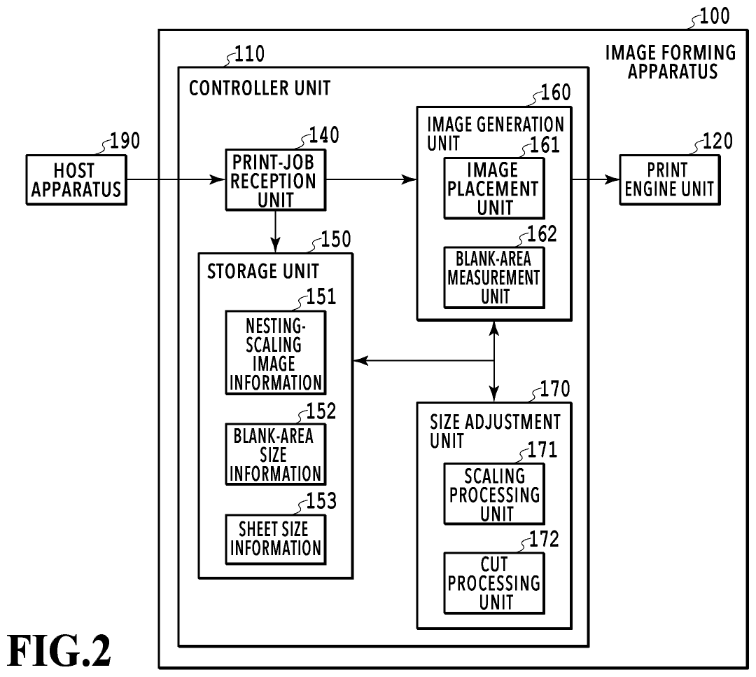

FIG. 2 is a diagram illustrating an example of the software configuration implemented in the controller unit of the image forming apparatus according to the present embodiment. This configuration is implemented by the main controller 111 executing a program.

A print-job reception unit 140, receiving a print job from the host apparatus 190, stores the size and nesting-scaling image information 151 of an image included in the print job into a storage unit 150 and outputs the image data included in the print job to an image generation unit 160.

The storage unit 150 stores the nesting-scaling image information 151, blank-area size information 152, and sheet size information 153 into the RAM 114 or the HDD 118.

The image generation unit 160 places an image included in a print job into a print area of a sheet and generates a print image for printing. The image generation unit 160 includes an image placement unit 161 that places the image in a blank area of the print area and a blank-area measurement unit 162 that measures the size of the blank area.

A size adjustment unit 170 adjusts the size of an image to be placed in the print area according to the nesting-scaling image information 151. The size adjustment unit 170 includes a scaling processing unit 171 and a cut processing unit 172 and is configured to adjust the size of an image by enlarging or reducing the size of the image or cutting out part of the image.

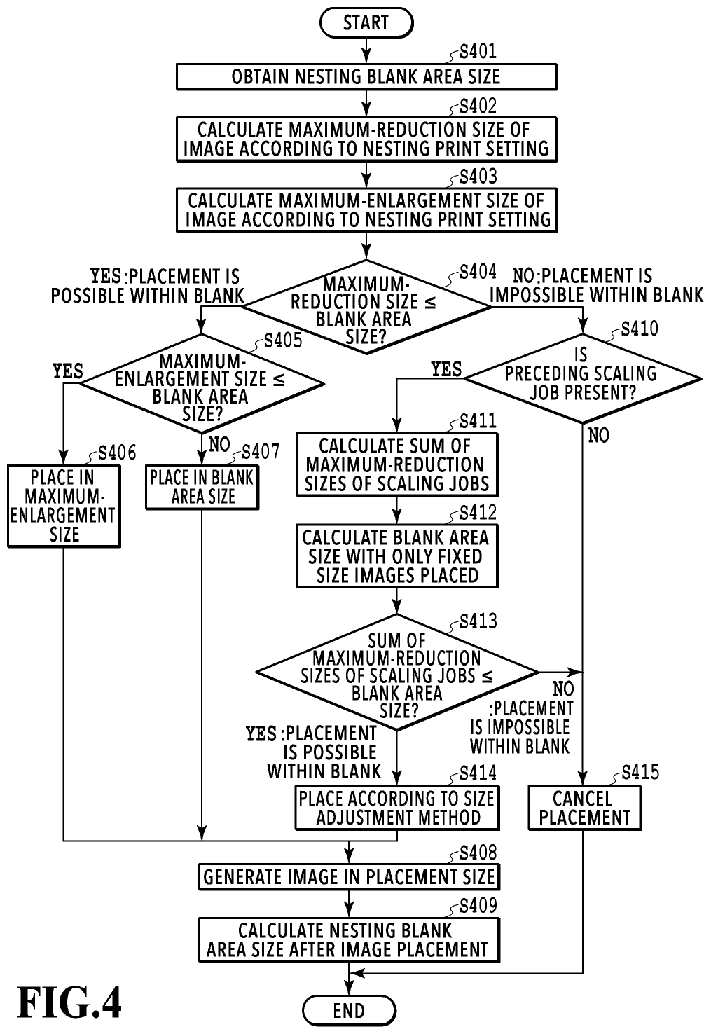

Detailed processing of the image generation unit 160 and the size adjustment unit 170 will be described later with reference to the flowchart illustrated in FIG. 4.

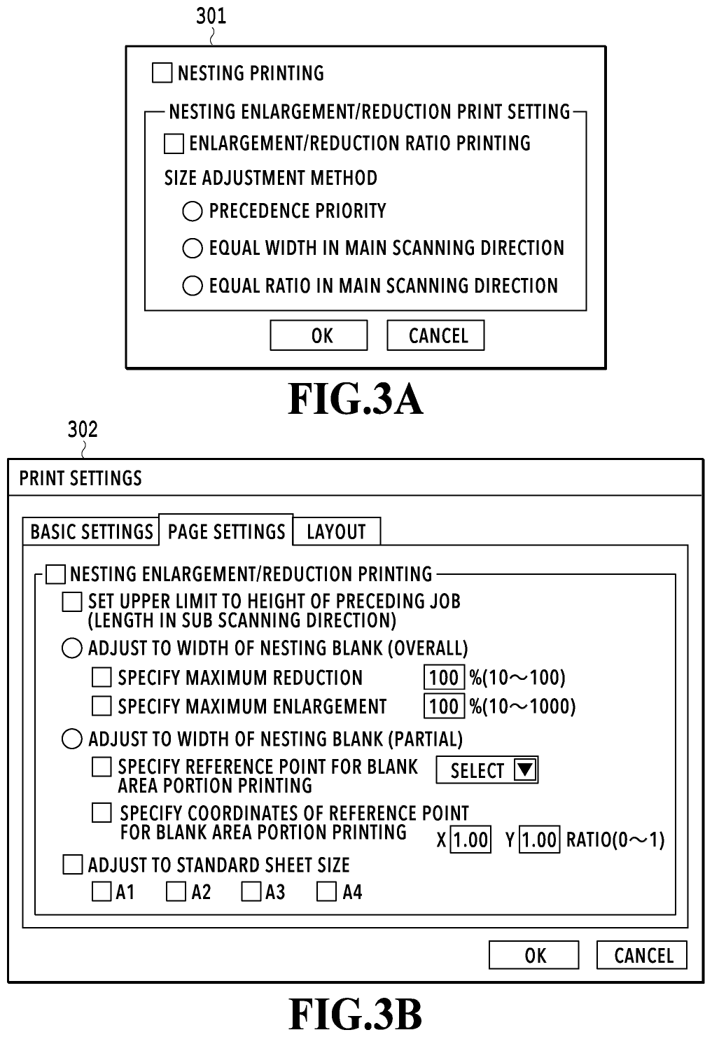

FIG. 3A is a schematic diagram illustrating a setting screen 301 for nesting printing, displayed on the input-output apparatus 117. Checking the checkbox of nesting printing on the setting screen 301 enables nesting printing, putting the image forming apparatus 100 into a nesting print mode. Nesting enlargement/reduction print settings on the setting screen 301 are settings for image data on which a nesting enlargement/reduction print setting is specified by the printer driver of the host apparatus 190. “Enlargement/reduction ratio printing” in the nesting enlargement/reduction print settings is a print mode in which the scaling ratio (resizing ratio) is printed in a margin area between pieces of print image data. In a case in which enlargement/reduction ratio printing is enabled, the size adjustment method in the case in which there are a plurality of print jobs including nesting targets allowed to be scaled (resized) can be selected out of three methods. In the present embodiment, a print job in which enlargement or reduction of size is set for nesting is referred to as a scaling job.

FIG. 3B is a schematic diagram illustrating a page setting screen 302 for print setting by the printer driver in the host apparatus 190. To perform a nesting enlargement/reduction printing, the nesting enlargement/reduction printing is enabled on the page setting screen 302 before executing printing. The nesting-scaling-print setting information set in the setting for nesting enlargement/reduction printing is transmitted together with image data as a print job to the image forming apparatus 100. The main controller 111 of the image forming apparatus 100 stores the received print job into a storage apparatus such as the RAM 114 or the HDD 118 and analyzes the print job to determine a placement position of the image data.

FIG. 4 is a flowchart illustrating processing in the image forming apparatus 100 for analyzing a print job received in the nesting print mode to determine a placement position of the image data, and generating image data for printing.

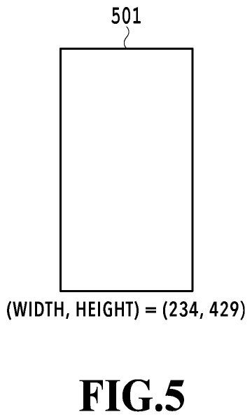

First, a procedure for determining a placement position of image data not including nesting-scaling-print setting information will be described. FIG. 5 is a schematic diagram illustrating an image 501 to be printed in nesting printing by the image forming apparatus 100. The size of the image 501 is 234 mm in width and 429 mm in height. Here, “width” corresponds to the main scanning direction (a direction perpendicular to the sheet conveyance direction), and “height” corresponds to the sub scanning direction (the sheet conveyance direction). The image data of the image 501 is transmitted to the image forming apparatus 100 as part of a print job by the printer driver in the host apparatus 190. In the image forming apparatus 100, the print job information received by the main controller 111 is stored in a storage apparatus such as the RAM 114 or the HDD 118, and the print job is then analyzed as described below according to the flowchart illustrated in FIG. 4 to determine a placement position of the image 501 included in the print job.

### <Image 501>

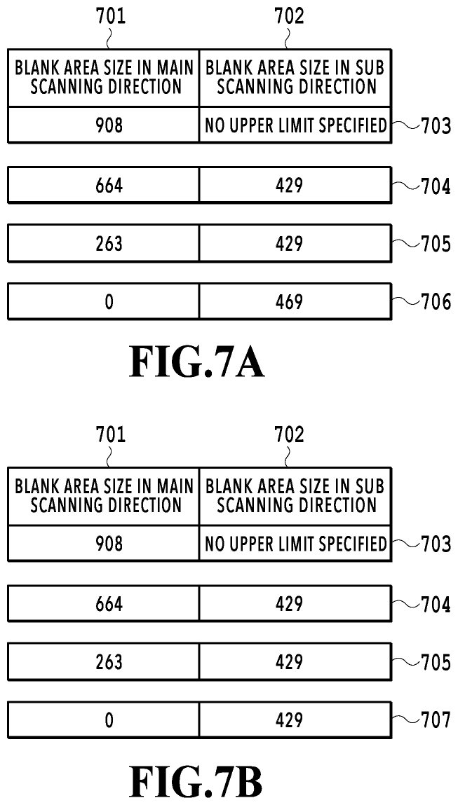

In S401, the image placement unit 161 of the image generation unit 160 obtains, from the RAM 114, blank-area size information 152 in the main scanning direction available for nesting printing. In the present embodiment, when a nesting print mode starts, the blank area size in the main scanning direction is set to the width of the roll paper, and the blank area size in the sub scanning direction is set to a value indicating “no upper limit specified”. FIGS. 7A and 7B illustrate blank-area size information in which a blank area size 701 in the main scanning direction and a blank area size 702 in the sub scanning direction are recorded at every image placement. In the present embodiment, the roll-paper width is assumed to be 908 mm. Thus, before image placement, the blank-area size information 703 in the main scanning direction is set to 908 mm, and the blank-area size information 703 in the sub scanning direction is set to “no upper limit specified”. Rows 704 to 706 in FIG. 7A and rows 704, 705, and 707 in FIG. 7B indicate blank-area size information after a first image is placed, blank-area size information after a second image is placed, and blank-area size information after a third image is placed. For convenience of explanation in the present embodiment, it is assumed that there is no margin on both sides of the roll paper 600 in the main scanning direction, and that the margin size between pieces of image data is 10 mm.

In S402, the image placement unit 161 determines the maximum-reduction size of the image 501. In the case in which the image data of the image 501 includes nesting-scaling-print setting information, the maximum-reduction size denotes the size when the reduction ratio that makes the size smallest within the reduction range permitted in the nesting-scaling-print setting information is applied. Note that nesting-scaling-print setting information is not generated on the image data of the image 501 by using the printer driver, and thus the image data of the image 501 does not include nesting-scaling-print setting information. In such a case in which image data does not include nesting-scaling-print setting information, nesting-scaling-print setting information in which the maximum-reduction size is set equal to the image size is generated.

In S403, the image placement unit 161 determines the maximum-enlargement size of the image 501. In the case in which the image data of the image 501 includes nesting-scaling-print setting information, the maximum-enlargement size denotes the size when the enlargement ratio that makes the size largest within the enlargement range permitted in the nesting-scaling-print setting information is applied. Note that nesting-scaling-print setting information is not generated on the image data of the image 501 by using the printer driver, and thus the maximum-enlargement size is not specified in the nesting-scaling-print setting information generated in S402. In this case, the maximum-enlargement size in the nesting-scaling-print setting information is set equal to the image size.

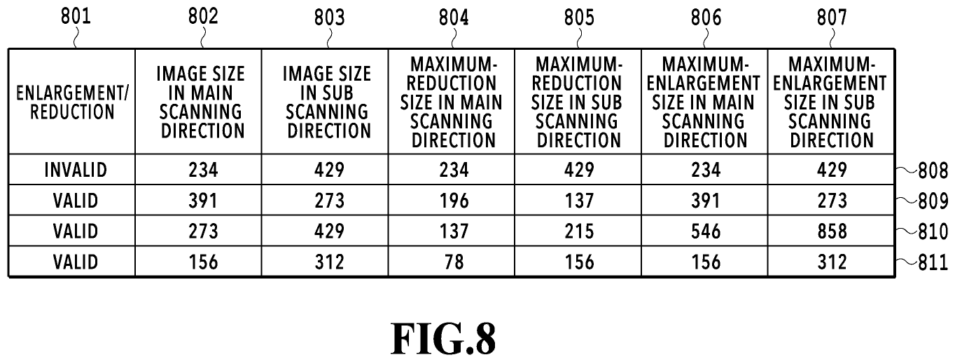

FIG. 8 is a table illustrating the nesting-scaling image information on a plurality of pieces of image data. The item 801 holds information for specifying whether the enlargement or reduction of an image is valid or invalid. In the case in which the item 801 holds information indicating “valid”, it indicates that a print job including the image data is a scaling job. The item 802 holds the image size in the main scanning direction originally defined in the image data. The item 803 holds the image size in the sub scanning direction originally defined in the image data. The item 804 holds the maximum-reduction size in the main scanning direction of the image data. The item 805 holds the maximum-reduction size in the sub scanning direction of the image data. The item 806 holds the maximum-enlargement size in the main scanning direction of the image data. The item 807 holds the maximum-enlargement size in the sub scanning direction of the image data. The maximum-reduction size and the maximum-enlargement size determined in S402 and S403 are held in the nesting-scaling image information 808. As described above, information defining the size adjustment range within which the size of an image can be adjusted is registered in the nesting-scaling image information.

In S404, the image placement unit 161 determines whether the maximum-reduction size of the image 501 is within the blank area size in the main scanning direction obtained in S401. If the maximum-reduction size in the main scanning direction of the image 501 is within the blank area size, the process proceeds to S405, and if not, the process proceeds to S410. Since the maximum-reduction size in the main scanning direction of the image 501, 234 mm, is smaller than the blank area size in the main scanning direction, 908 mm, the image 501 can be placed in the blank area.

In S405, the image placement unit 161 determines whether the maximum-enlargement size of the image 501 is within the blank area size in the main scanning direction obtained in S401 by the image placement unit 161. If the maximum-enlargement size in the main scanning direction of the image 501 is within the blank area size, the process proceeds to S406, and if not, the process proceeds to S407. Since the maximum-enlargement size in the main scanning direction of the image 501, 234 mm, is smaller than the current blank area size in the main scanning direction, 908 mm, the image 501 can be placed in the blank area.

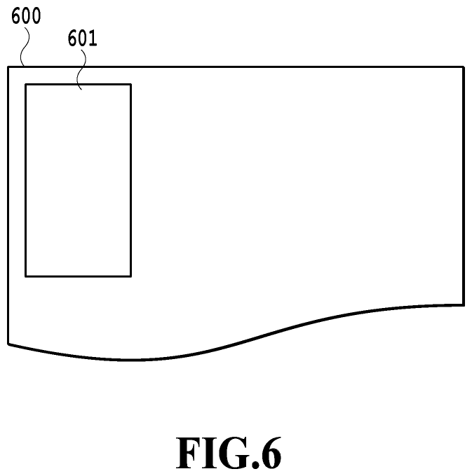

In S406, the image placement unit 161 causes the scaling processing unit 171 of the size adjustment unit 170 to adjust the size of the image 501 to the maximum-enlargement size and places the image 501 in the current blank area of the roll paper 600. FIG. 6 illustrates an area 601 in which the image 501 is placed on the roll paper 600.

In S408, the image placement unit 161 generates image data of the image 501, specifying the size after the placement position is determined to the image processing unit 116, and stores the generated image data into a storage apparatus such as the RAM 114 or the HDD 118.

In S409, the blank-area measurement unit 162 of the image generation unit 160 calculates the nesting blank area size after the image 501 is placed. The size of the nesting blank area in the main scanning direction is calculated by subtracting the maximum-enlargement size of the image 501, 234 mm, and the margin area size between images, 10 mm, from the blank area size before the image placement, 908 mm, and the result is 664 mm. The blank area size in the sub scanning direction is set equal to the height of the image placed in the preceding nesting job and, in this case, is set to the maximum-enlargement size, 429 mm, which is the size of the image 501 in the sub scanning direction. The blank area size in the sub scanning direction is used in the case in which a setting to set the upper limit to the height of the images placed in the preceding nesting jobs is enabled on the page setting screen 302. The size of the nesting blank area after the image 501 is placed is now as indicated in the blank-area size information 704.

### <Image 901-1>(Scaling Processing)

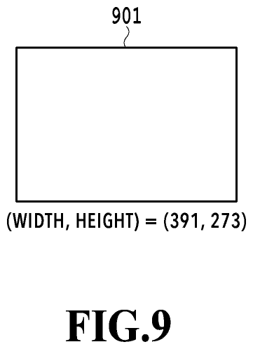

Next, a description is given of a placement-position determination procedure for placing an image based on image data including nesting-scaling-print setting information, in the nesting blank area excluding the area 601 corresponding to the image 501 placed immediately beforehand as illustrated in FIG. 6. FIG. 9 is a schematic diagram illustrating an image 901 to be printed in nesting printing by the image forming apparatus 100. The size of the image 901 is 391 mm in width and 273 mm in height. The image data of the image 901 is subjected to nesting scaling setting by the printer driver of the host apparatus 190 and is transmitted to the image forming apparatus 100 as print job information.

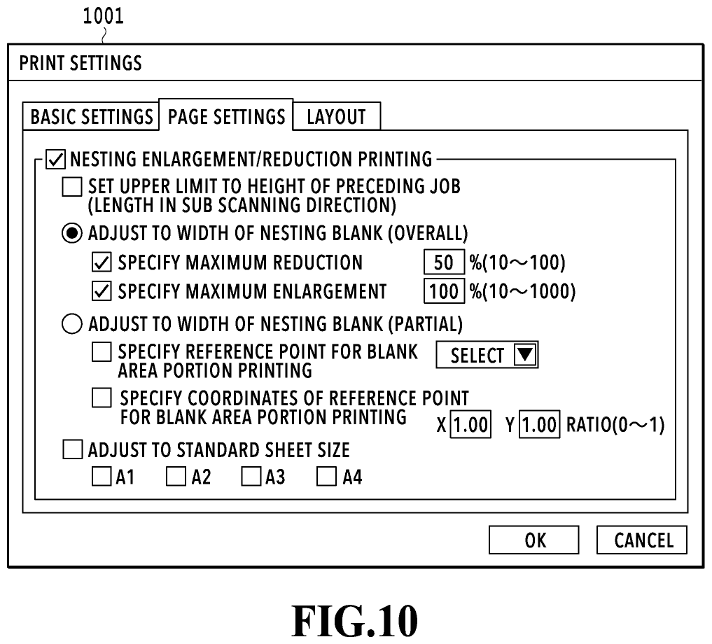

FIG. 10 is a schematic diagram illustrating a page setting screen 1001 for setting for nesting scaling printing of the image data of the image 901. In the setting for nesting scaling printing, maximum reduction is set to 50%, and maximum enlargement is set to 100%. The image forming apparatus 100 stores the print job information received by the main controller 111 into a storage apparatus such as the RAM 114 or HDD 118 and analyzes the print job information to determine the placement position of the image 901.

In S401, the image placement unit 161 of the image generation unit 160 obtains the blank area size in the main scanning direction available for nesting printing, from the blank-area size information 704. Here, the nesting blank area size is 664 mm in the main scanning direction and 429 mm in the sub scanning direction.

In S402, the image placement unit 161 refers to the nesting-scaling-print setting information included in the image data of the image 901 and calculates the maximum-reduction size to which reduction is permitted. Here, since the maximum-reduction size of the image 901 is 50%, the maximum-reduction size is 196 mm in the main scanning direction and 137 mm in the sub scanning direction.

In S403, since enlargement is permitted in the nesting-scaling-print setting information included in the image data of the image 901, the image placement unit 161 calculates the maximum-enlargement size according to the nesting-scaling-print setting information. Here, since the maximum-enlargement size of the image 901 is 100%, the maximum-enlargement size is 391 mm in the main scanning direction and 273 mm in the sub scanning direction. In scaling an image, the aspect ratio of the image is maintained. The maximum-reduction size and the maximum-enlargement size calculated in S402 and S403 are stored in the nesting-scaling image information 809.

In S404, the image placement unit 161 determines whether the maximum-reduction size of the image 901 is within the nesting blank area size obtained in S401. Since the maximum-reduction size of the image 901, 196 mm, is smaller than the size of the nesting blank area in the main scanning direction, 664 mm, the image 901 can be placed in the nesting blank area.

In S405, the image placement unit 161 determines whether the maximum-enlargement size of the image 901 is within the nesting blank area size obtained in S401. Since the maximum-enlargement size of the image 901, 391 mm, is smaller than the size of the nesting blank area in the main scanning direction, 664 mm, the image 901 in the maximum-enlargement size can be placed in the nesting blank area.

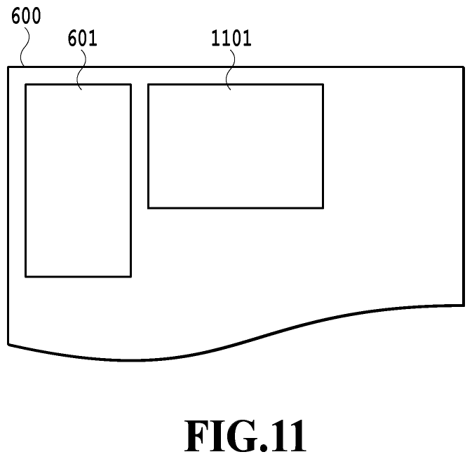

In S406, the image placement unit 161 causes the scaling processing unit 171 of the size adjustment unit 170 to adjust the size of the image 901 to the maximum-enlargement size and places the image 901 in the nesting blank area. FIG. 11 is a schematic diagram illustrating the area 1101 in which the image 901 is placed on the roll paper 600. The area 1101 is placed at a position adjacent in the main scanning direction to the area 601 in which the image 501 is placed in the preceding nesting job.

In S408, the image placement unit 161 generates the image data of the image 901, specifying the size after the placement position is determined to the image processing unit 116, and stores the generated image data into a storage apparatus such as the RAM 114 or the HDD 118. In the case in which the enlargement/reduction ratio printing is enabled in the setting screen 301, the main controller 111 instructs the image processing unit 116 to add, to the image data of the image 901, the scaling ratio information to be printed in a blank area around the print image.

In S409, the blank-area measurement unit 162 of the image generation unit 160 calculates the nesting blank area size after the image 501 and the image 901 are placed. The size of the nesting blank area in the main scanning direction is calculated by subtracting the maximum-enlargement size of the image 901, 391 mm, and the margin size between images, 10 mm, from 664 mm before the image 901 is placed, and the result is 263 mm. The size of the nesting blank area in the sub scanning direction is not updated because the size of the preceding image 501 in the sub scanning direction, 429 mm, is larger than the size of the placed image 901 in the sub scanning direction, 273 mm. The size of the nesting blank area after the image 901 is placed is now as indicated in the blank-area size information 705.

### <Image 901-2>(Scaling Processing)

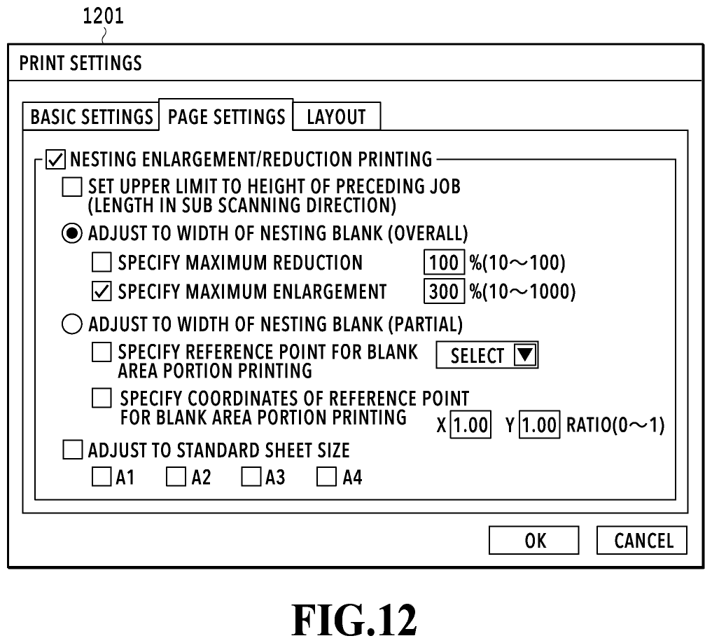

Next, a description is given of a placement-position determination procedure for placing the image 901 with the setting for nesting scaling printing illustrated in FIG. 12 set by the printer driver of the host apparatus 190, in the nesting blank area excluding the area 601 corresponding to the image 501 placed immediately beforehand as illustrated in FIG. 6.

FIG. 12 is a schematic diagram illustrating a page setting screen 1201 for setting for nesting scaling printing of the image data of the image 901. In the setting for nesting scaling printing, it is specified that the size should be adjusted to the width of the nesting blank area (the size in the main scanning direction) and that maximum enlargement is 300%.

In S401, the image placement unit 161 of the image generation unit 160 obtains the nesting blank area size from the blank-area size information 704. Here, the nesting blank area size is 664 mm in the main scanning direction and 429 mm in the sub scanning direction.

In S402, the image placement unit 161 refers to the nesting-scaling-print setting information included in the image data of the image 901 and calculates the maximum-reduction size to which reduction is permitted. Here, since the maximum-reduction size of the image 901 is not specified, it is set to the minimum, 10%, and thus, the maximum-reduction size is 40 mm in the main scanning direction and 28 mm in the sub scanning direction.

In S403, the image placement unit 161 refers to the nesting-scaling-print setting information included in the image data of the image 901 and calculates the maximum-enlargement size to which enlargement is permitted. Here, since the maximum-enlargement size of the image 901 is set to 300%, the maximum-enlargement size is 1173 mm in the main scanning direction and 819 mm in the sub scanning direction.

In S404, the image placement unit 161 determines whether the maximum-reduction size of the image 901 is within the nesting blank area size obtained in S401. Since the maximum-reduction size of the image 901, 40 mm, is smaller than the size of the nesting blank area in the main scanning direction, 664 mm, the image 901 can be placed in the nesting blank area.

In S405, the image placement unit 161 determines whether the maximum-enlargement size of the image 901 is within the nesting blank area size obtained in S401. Since the maximum-enlargement size of the image 901, 1173 mm, is larger than the size of the nesting blank area in the main scanning direction, 664 mm, the image 901 can be enlarged and placed to fit the nesting blank area.

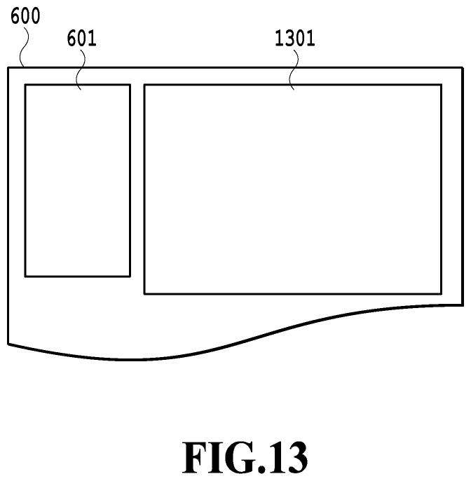

In S407, the image placement unit 161 causes the scaling processing unit 171 of the size adjustment unit 170 to enlarge the image 901 to the size of the nesting blank area in the main scanning direction and places the image 901 with an adjusted size of 664 mm in the main scanning direction and 469 mm in the sub scanning direction. FIG. 13 is a schematic diagram illustrating the area 1301 in which the image 901 is placed on the roll paper 600. The area 1301 is placed at a position adjacent in the main scanning direction to the area 601 in which the image 501 is placed in the preceding nesting job.

In S408, the image placement unit 161 generates the image data of the enlarged image 901, specifying the size after the placement position is determined to the image processing unit 116, and stores the generated image data into a storage apparatus such as the RAM 114 or the HDD 118.

In S409, the blank-area measurement unit 162 of the image generation unit 160 calculates the nesting blank area size after the image 501 and the image 901 are placed. The size of the nesting blank area in the main scanning direction is calculated by subtracting the size of the placed image 901 in the main scanning direction, 664 mm, from 664 mm before the image 901 is placed, and the result is 0 mm. The size of the nesting blank area in the sub scanning direction is updated to 469 mm because the size of the placed image 901 in the sub scanning direction, 469 mm, is larger than the size of the preceding image 501 in the sub scanning direction, 429 mm. The size of the nesting blank area after the image 901 is placed is now as indicated in the blank-area size information 706.

### <Image 901-3>(Scaling Processing)

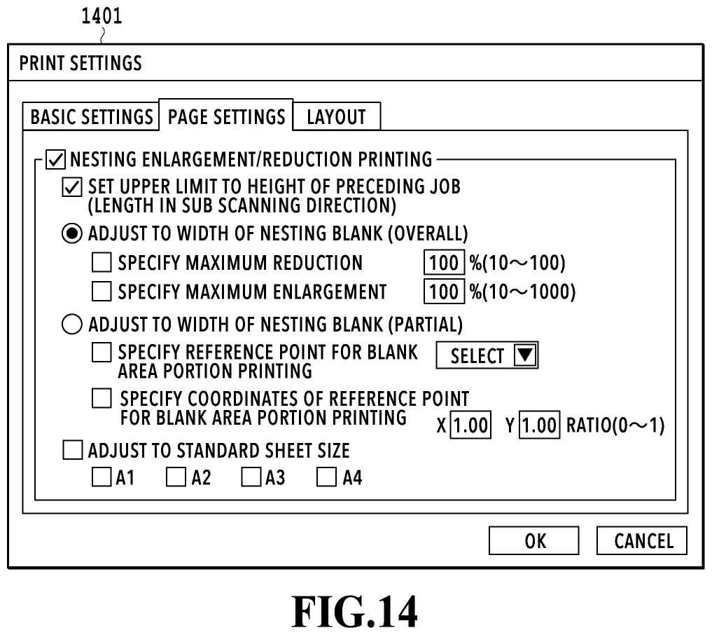

Next, a description is given of a placement-position determination procedure for placing the image 901 with the setting for nesting scaling printing illustrated in FIG. 14 set by the printer driver of the host apparatus 190, in the nesting blank area excluding the area 601 corresponding to the image 501 placed immediately beforehand as illustrated in FIG. 6.

FIG. 14 is a schematic diagram illustrating a page setting screen 1401 for setting for nesting scaling printing of the image data of the image 901. In the setting for nesting scaling printing, it is specified that the size should be adjusted to the width of the nesting blank area (the size in the main scanning direction) and that the size of the preceding job in the sub scanning direction is the upper limit.

In S401, the image placement unit 161 of the image generation unit 160 obtains the nesting blank area size from the blank-area size information 704. Here, the nesting blank area size is 664 mm in the main scanning direction and 429 mm in the sub scanning direction.

In S402, the image placement unit 161 refers to the nesting-scaling-print setting information included in the image data of the image 901 and calculates the maximum-reduction size to which reduction is permitted. Here, since the maximum-reduction size of the image 901 is not specified, it is set to the minimum, 10%, and thus, the maximum-reduction size is 40 mm in the main scanning direction and 28 mm in the sub scanning direction.

In S403, the image placement unit 161 refers to the nesting-scaling-print setting information included in the image data of the image 901 and calculates the maximum-enlargement size to which enlargement is permitted. Here, since the maximum-enlargement size of the image 901 is not specified, it is set to the maximum, 1000%, and thus, the maximum-enlargement size is 3910 mm in the main scanning direction and 2730 mm in the sub scanning direction. However, in the nesting scaling print setting of the image 901, the upper limit is set to the size of the preceding job in the sub scanning direction, 429 mm. Thus, the maximum-enlargement size of the image 901 is 429 mm in the sub scanning direction and 610 mm in the main scanning direction.

In S404, the image placement unit 161 determines whether the maximum-reduction size of the image 901 is within the nesting blank area size obtained in S401. Since the maximum-reduction size of the image 901, 40 mm, is smaller than the size of the nesting blank area in the main scanning direction, 664 mm, the image 901 can be placed in the nesting blank area.

In S405, the image placement unit 161 determines whether the maximum-enlargement size of the image 901 is within the nesting blank area size obtained in S401. Since the maximum-enlargement size of the image 901, 610 mm, is smaller than the size of the nesting blank area in the main scanning direction, 664 mm, the image 901 in the maximum-enlargement size can be placed in the nesting blank area.

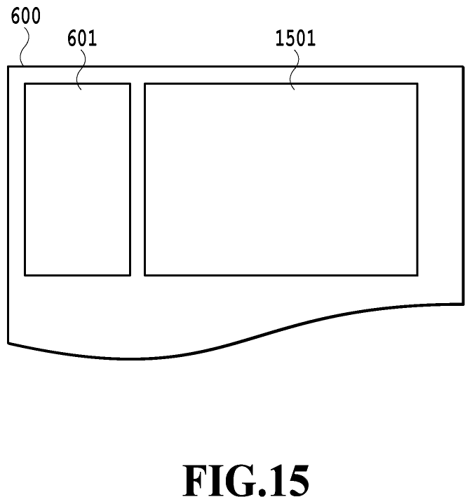

In S406, the image placement unit 161 causes the scaling processing unit 171 of the size adjustment unit 170 to adjust the size of the image 901 to the maximum-enlargement size and places the image 901 in the nesting blank area. FIG. 15 is a schematic diagram illustrating the area 1501 in which the image 901 is placed on the roll paper 600. The area 1501 is placed at a position adjacent in the main scanning direction to the area 601 in which the image 501 is placed in the preceding nesting job.

In S408, the image placement unit 161 generates the image data of an enlarged image 901, specifying the size after the placement is determined to the image processing unit 116, and stores the generated image data into a storage apparatus such as the RAM 114 or the HDD 118.

In S409, the blank-area measurement unit 162 of the image generation unit 160 calculates the nesting blank area size after the image 501 and the image 901 are placed. The size of the nesting blank area in the main scanning direction is calculated by subtracting the size of the placed image 901 in the maximum-enlargement size in the main scanning direction, 429 mm, and the margin size between images, 10 mm, from 664 mm before the image 901 is placed, and the result is 225 mm. The size of the nesting blank area in the sub scanning direction is not updated because the size of the preceding image 501 in the sub scanning direction, 429 mm, is larger than the size of the placed image 901 in the sub scanning direction, 273 mm.

### <Image 901-4>(Scaling Processing)

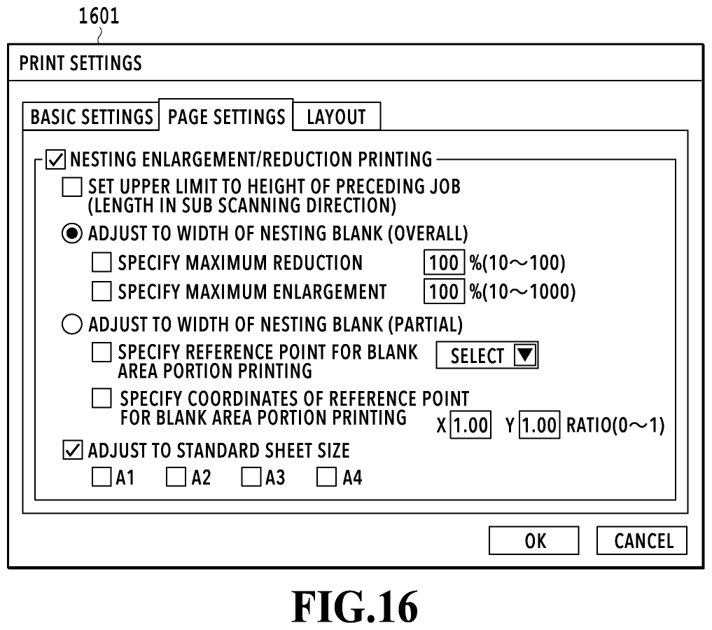

Next, a description is given of a placement-position determination procedure for placing the image 901 with the setting for nesting scaling printing illustrated in FIG. 16 set by the printer driver of the host apparatus 190, in the nesting blank area excluding the area 601 corresponding to the image 501 placed immediately beforehand as illustrated in FIG. 6.

FIG. 16 is a schematic diagram illustrating a page setting screen 1601 for setting for nesting scaling printing of the image data of the image 901. In the setting for nesting scaling printing, it is specified that the size should be adjusted to the width of the nesting blank area (the size in the main scanning direction), and the size should be adjusted to a standard sheet size. It is also specified that a standard sheet size should be one of A2, A3, and A4.

In S401, the image placement unit 161 of the image generation unit 160 obtains the nesting blank area size from the blank-area size information 704. Here, the nesting blank area size is 664 mm in the main scanning direction and 429 mm in the sub scanning direction.

In S402, the image placement unit 161 refers to the nesting-scaling-print setting information included in the image data of the image 901 and calculates the maximum-reduction size to which reduction is permitted. Here, it is specified that the image 901 should be adjusted to one of A2, A3, and A4. The size of landscape A2 is 594 mm in the main scanning direction and 420 mm in the sub scanning direction. The size of landscape A3 is 420 mm in the main scanning direction and 297 mm in the sub scanning direction. The size of landscape A4 is 297 mm in the main scanning direction and 210 mm in the sub scanning direction. Since the minimum size is A4, the maximum-reduction size of the image 901 is 297 mm in the main scanning direction and 210 mm in the sub scanning direction. Although the description of the present embodiment is based on an example in which a standard sheet is placed in the landscape orientation, a configuration involving setting the orientation in the page setting screen 1601 is possible.

In S403, the image placement unit 161 refers to the nesting-scaling-print setting information included in the image data of the image 901 and calculates the maximum-enlargement size to which enlargement is permitted. Since it is specified in the nesting-scaling-print setting information that the size should be adjusted to a standard sheet size, and the maximum size is A2, the maximum-enlargement size of the image 901 is 594 mm in the main scanning direction and 420 mm in the sub scanning direction.

In S404, the image placement unit 161 determines whether the maximum-reduction size of the image 901 is within the blank area size. Since the maximum-reduction size of the image 901, 297 mm, is smaller than the size of the nesting blank area in the main scanning direction, 664 mm, the image 901 can be placed in the nesting blank area.

In S405, the image placement unit 161 determines whether the maximum-enlargement size of the image 901 is within the nesting blank area size obtained in S401. Since the maximum-enlargement size of the image 901, 594 mm, is smaller than the size of the nesting blank area in the main scanning direction, 664 mm, the image 901 in the maximum-enlargement size can be placed in the nesting blank area.

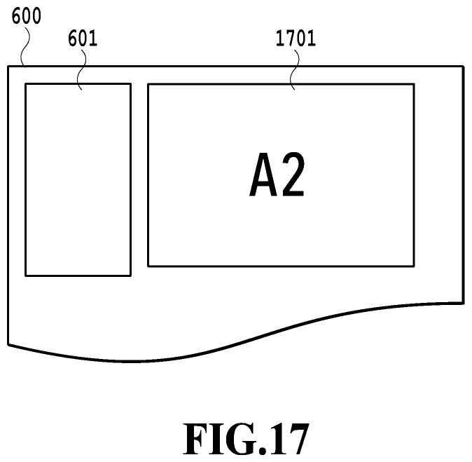

In S406, the image placement unit 161 causes the scaling processing unit 171 of the size adjustment unit 170 to adjust the size of the image 901 to the maximum-enlargement size and places the image 901 in the nesting blank area. FIG. 17 is a schematic diagram illustrating the area 1701 in which the image 901 is placed on the roll paper 600.

In S408, the image placement unit 161 causes the scaling processing unit 171 of the size adjustment unit 170 to generate the image data of an enlarged image 901, specifying the size after the placement is determined to the image processing unit 116, and stores the generated image data into a storage apparatus such as the RAM 114 or the HDD 118.

In S409, the main controller 111 calculates the nesting blank area size after the image 501 and the image 901 are placed. The size of the nesting blank area in the main scanning direction is calculated by subtracting of the size of the placed image 901 in the maximum-enlargement size in the main scanning direction, 594 mm, and the margin size between images, 10 mm, from 664 mm before the image 901 is placed, and the result is 60 mm. The blank size of the nesting blank area in the sub scanning direction is not updated because the size of the preceding image 501 in the sub scanning direction, 429 mm, is larger than the size of the placed image 901 in the sub scanning direction, 420 mm.

### <Image 1801-1>(Scaling Processing)

A description is given of a placement-position determination procedure for adding an image 1801 subjected to nesting scaling print setting, in the nesting blank area excluding the area 601 corresponding to the image 501 and the area 1101 corresponding to the image 901 placed immediately beforehand, as illustrated in FIG. 11.

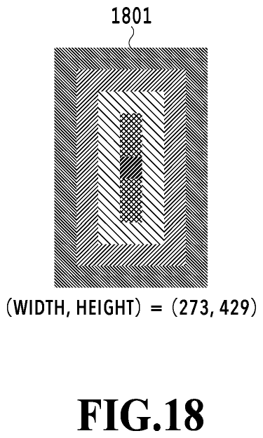

FIG. 18 is a schematic diagram illustrating an image 1801 to be printed in nesting printing by the image forming apparatus 100. The size of the image 1801 is 273 mm in width and 429 mm in height. The image 1801 is subjected to setting for nesting scaling printing by the printer driver of the host apparatus 190 and is transmitted to the image forming apparatus 100 as part of print job information.

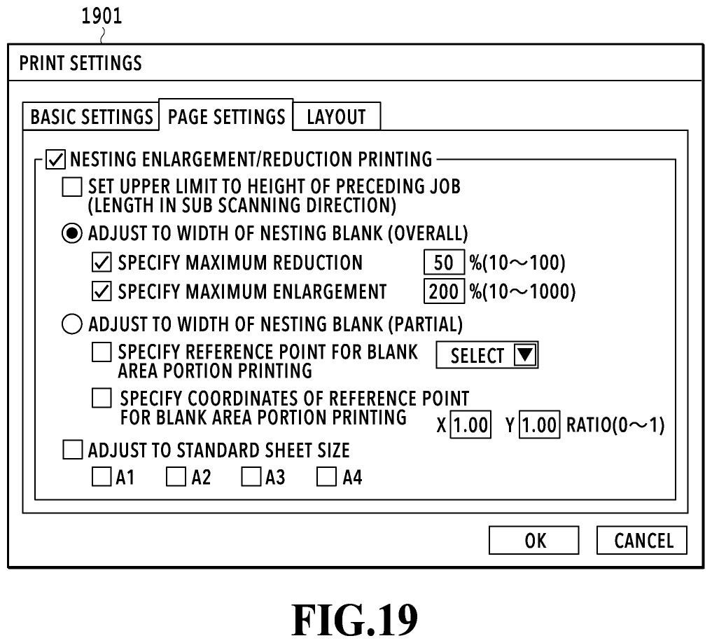

FIG. 19 is a schematic diagram illustrating a page setting screen 1901 for setting for nesting scaling printing of the image data of the image 1801. In the setting for nesting scaling printing, maximum reduction is specified to be 50%, and maximum enlargement is specified to be 200%. The image forming apparatus 100 stores the print job information received by the main controller 111 into a storage apparatus and analyzes the print job information to determine the placement position of the image 1801.

In S401, the image placement unit 161 of the image generation unit 160 obtains the blank area size in the main scanning direction available for nesting printing, from the blank-area size information 705. The blank size in the main scanning direction is 263 mm, and the blank size in the sub scanning direction is 429 mm.

In S402, since reduction is permitted in the nesting-scaling-print setting information included in the image data of the image 1801, the image placement unit 161 calculates the maximum-reduction size according to the nesting-scaling-print setting information. Here, since the maximum-reduction size of the image 1801 is 50%, the maximum-reduction size is 137 mm in the main scanning direction and 215 mm in the sub scanning direction.

In S403, since enlargement is permitted in the nesting-scaling-print setting information included in the image data of the image 1801, the image placement unit 161 calculates the maximum-enlargement size according to the nesting-scaling-print setting information. Here, since the maximum-enlargement size of the image 1801 is 200%, the maximum-enlargement size is 546 mm in the main scanning direction and 858 mm in the sub scanning direction. The maximum-reduction size and the maximum-enlargement size calculated in S402 and S403 are stored in the nesting-scaling image information 810.

In S404, the image placement unit 161 determines whether the maximum-reduction size of the image 1801 is within the nesting blank area size obtained in S401. Since the maximum-reduction size of the image 1801, 137 mm, is smaller than the size of the nesting blank area in the main scanning direction, 263 mm, the image 1801 can be placed in the nesting blank area.

In S405, the image placement unit 161 determines whether the maximum-enlargement size of the image 1801 is within the nesting blank area size obtained in S401. Since the maximum-enlargement size of the image 1801, 391 mm, is larger than the size of the nesting blank area in the main scanning direction, 263 mm, the image 1801 can be enlarged and placed to fit the nesting blank area size.

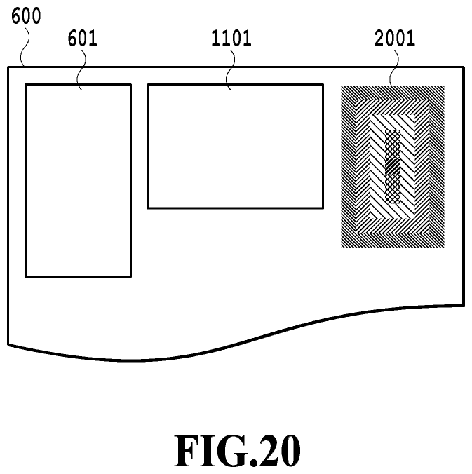

In S407, the image placement unit 161 causes the scaling processing unit 171 of the size adjustment unit 170 to enlarge the image 1801 to the size of the nesting blank area in the main scanning direction and places the image 1801 with an adjusted size of 263 mm in the main scanning direction and 395 mm in the sub scanning direction. FIG. 20 is a schematic diagram illustrating the area 2001 in which the image 1801 is placed on the roll paper 600. The area 2001 is placed at a position adjacent in the main scanning direction to the area 1101 in which the image 901 is placed in the preceding nesting job.

In S408, the image placement unit 161 generates the image data of an enlarged image 1801, specifying the size after the placement position is determined to the image processing unit 116, and stores the generated image data into a storage apparatus such as the RAM 114 or the HDD 118.

In S409, the blank-area measurement unit 162 of the image generation unit 160 calculates the nesting blank area size after the image 501, the image 901, and the image 1801 are placed. The size of the nesting blank area in the main scanning direction is calculated by subtracting the size of the placed image 1801 in the scanning direction, 263 mm, from 263 mm before the image 1801 is placed, and the result is 0 mm. The size of the nesting blank area in the sub scanning direction is not updated because the size of the preceding image 501 in the sub scanning direction, 429 mm, is larger than the size of the placed image 1801 in the sub scanning direction, 395 mm. The size of the nesting blank area after the image 1801 is placed is now as indicated in the blank-area size information 707.

### <Image 1801-2>(Cut Processing)

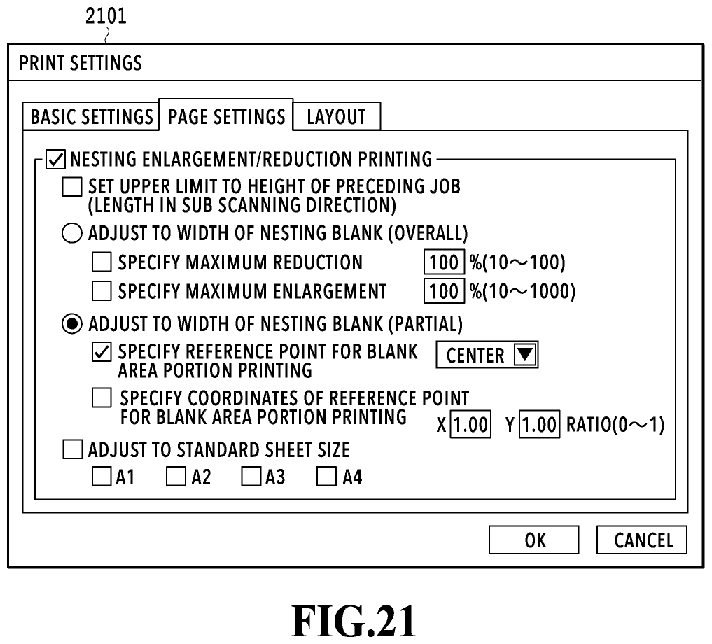

A description is given of a placement-position determination procedure for placing the image 1801 subjected to another nesting scaling print setting, in the nesting blank area excluding the area 601 corresponding to the image 501 and the area 1101 corresponding to the image 901 placed immediately beforehand, as illustrated in FIG. 11. FIG. 21 is a schematic diagram illustrating a page setting screen 2101 for setting for nesting scaling printing of the image data of the image 1801.

In S401, the image placement unit 161 of the image generation unit 160 obtains the nesting blank area size from the blank-area size information 705. The nesting blank area size is 263 mm in the main scanning direction and 429 mm in the sub scanning direction, and thus, the processing in S402 and after will be described.

The following description is based on a case in which images have been placed as illustrated in FIG. 11, and in which the nesting scaling printing illustrated in the page setting screen 2101 in FIG. 21 is set for the image 1801. In the nesting scaling setting, it is specified that the range of the image 1801 within the blank area of the sheet with respect to the center coordinates of the image 1801 should be printed.

In S402, the image placement unit 161 refers to the nesting-scaling-print setting information on the image 1801 and determines from the setting that the minimum cut size is the size of the nesting blank area. Thus, the minimum cut size of the image 1801 is 263 mm in the main scanning direction and 429 mm in the sub scanning direction.

In S403, the image placement unit 161 refers to the nesting-scaling-print setting information on the image 1801 and determines from the setting that the maximum cut size is the size of the nesting blank area. Thus, the maximum cut size of the image 1801 is 263 mm in the main scanning direction and 429 mm in the sub scanning direction.

In S404, the image placement unit 161 determines whether the minimum cut size of the image 1801 is within the nesting blank area size obtained in S401. Since the minimum cut size of the image 1801, 263 mm, is equal to the size of the nesting blank area in the main scanning direction, 263 mm, the image 1801 can be placed in the nesting blank area.

In S405, the image placement unit 161 determines whether the maximum cut size of the image 1801 is within the nesting blank area size obtained in S401. Since the maximum cut size of the image 1801, 263 mm, is equal to the size of the nesting blank area in the main scanning direction, 263 mm, the image 1801 in the maximum cut size can be placed in the nesting blank area.

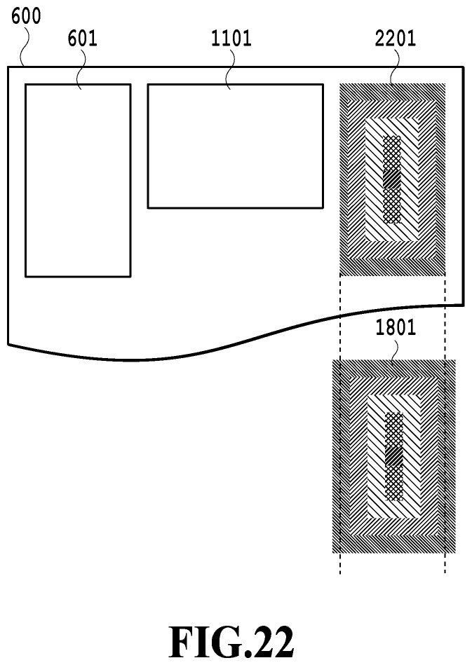

In S406, the image placement unit 161 causes the cut processing unit 172 of the size adjustment unit 170 to adjust the size of the image 1801 to the maximum cut size and places the image 1801 in the nesting blank area. FIG. 22 is a schematic diagram illustrating the area 2201 in which the image 1801 is placed on the roll paper 600 on which the images 501 and 901 have been placed. The range of the image 1801 within the nesting blank area with respect to the image center coordinates of the image 1801 is cut and placed in the area 2201. The size of the image 1801 in the main scanning direction is 273 mm, which is larger than the size of the nesting blank area in the main scanning direction, 263 mm. In addition, in the nesting-scaling-print setting information, it is specified that the portion of the image corresponding to the nesting blank area with respect to the center of the image should be printed. Thus, the main controller 111 instructs the image processing unit 116 to cut the image 1801 at the positions 131.5 mm away in the main scanning direction from the center line parallel to the sub scanning direction and to generate a final image to be placed in the nesting blank area. Although the description here is based on an example in which cut positions are determined with respect to the center of the image 1801, the image may be set such that the top left, top right, bottom left, or bottom right positions of the image and the nesting blank area are aligned as reference points, and the range of the image within the nesting blank area may be printed.

### <Image 1801-3>(Cut Processing)

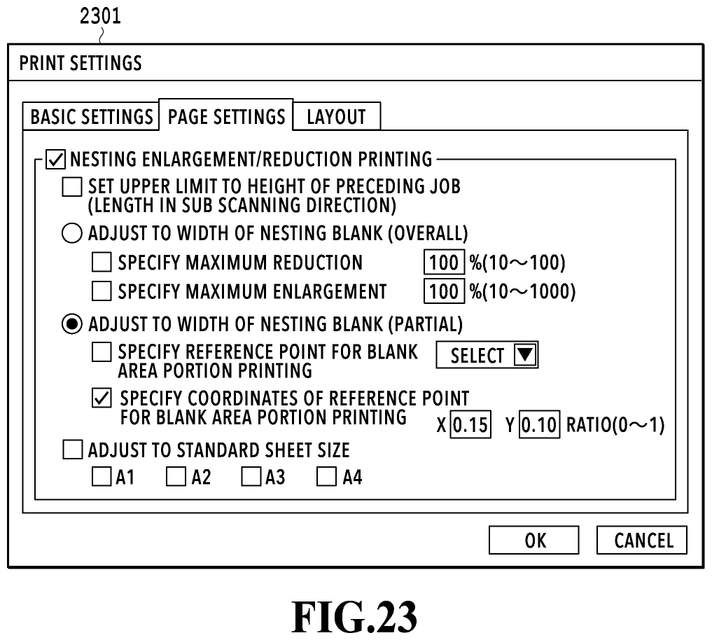

A description is given of a placement-position determination procedure for adding the image 1801 subjected to another nesting scaling print setting, in the nesting blank area excluding the area 601 corresponding to the image 501 and the area 1101 corresponding to the image 901 placed immediately beforehand, as illustrated in FIG. 11. FIG. 23 is a schematic diagram illustrating a page setting screen 2301 for setting for nesting scaling printing of the image data of the image 1801. In the nesting scaling print setting, it is specified that a reference point should be set to the point determined by moving the image by a specified distance from the top left of the image, and the portion of the image corresponding to the nesting blank area should be printed.

In S402, the image placement unit 161 of the image generation unit 160 refers to the nesting-scaling-print setting information included in the image data of the image 1801 and determines from the setting that the minimum cut size is the size of the nesting blank area. The minimum cut size of the image 1801 is 263 mm in the main scanning direction and 429 mm in the sub scanning direction.

In S403, the image placement unit 161 refers to the nesting-scaling-print setting information included in the image data of the image 1801 and determines from the setting that the maximum cut size is the size of the nesting blank area. The maximum cut size of the image 1801 is 263 mm in the main scanning direction and 429 mm in the sub scanning direction.

In S404, the image placement unit 161 determines whether the minimum cut size of the image 1801 is within the nesting blank area size. Regarding the size in the main scanning direction, since the blank area size, 263 mm, is equal to the maximum-reduction size of the image 1801, 263 mm, the image 1801 can be placed in the blank.

In S405, the image placement unit 161 determines whether the maximum cut size of the image 1801 is within the nesting blank area size. Regarding the size in the main scanning direction, since the blank area size, 263 mm, is equal to the maximum-enlargement size of the image 1801, 263 mm, the image 1801 can be placed in the blank.

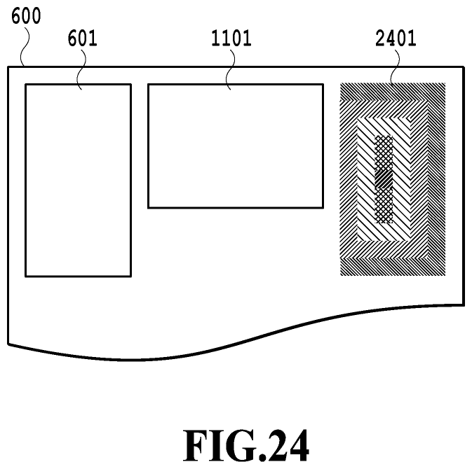

In S406, the image placement unit 161 causes the cut processing unit 172 of the size adjustment unit 170 to adjust the size of the image 1801 to the maximum cut size and places the image 1801 in the nesting blank area. FIG. 24 is a schematic diagram illustrating the area 2401 in which the image 1801 is placed on the roll paper 600 on which the images 501 and 901 have been placed. The size of the image 1801 in the main scanning direction, 273 mm, is larger than the size of the nesting blank area in the main scanning direction, 263 mm. In addition, in the nesting scaling setting, it is specified that a reference point should be set to the point determined by moving the image by a specified distance from the top left of the image, and that the portion of the image corresponding to the nesting blank area should be printed. Thus, the main controller 111 instructs the image processing unit 116 to shift the image 1801 to the left in the main scanning direction and upward in the sub scanning direction, to cut the portions extending beyond the nesting blank area, and to generate a final image to be placed in the nesting blank area.

### <Image 2501>(Scaling Processing)

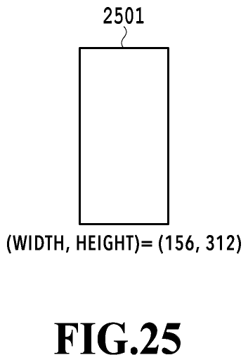

A description is given of a placement-position determination procedure in the case in which no nesting blank area is left after images were placed as illustrated in FIG. 20, and in which image data for which a nesting scaling print setting is specified is further added. FIG. 25 is a schematic diagram illustrating an image 2501 to be printed in nesting printing by the image forming apparatus 100. The size of the image 2501 is 156 mm in width and 312 mm in height. The image data of the image 2501 is subjected to nesting scaling setting by the printer driver of the host apparatus 190 and is transmitted to the image forming apparatus 100 as part of print job information.

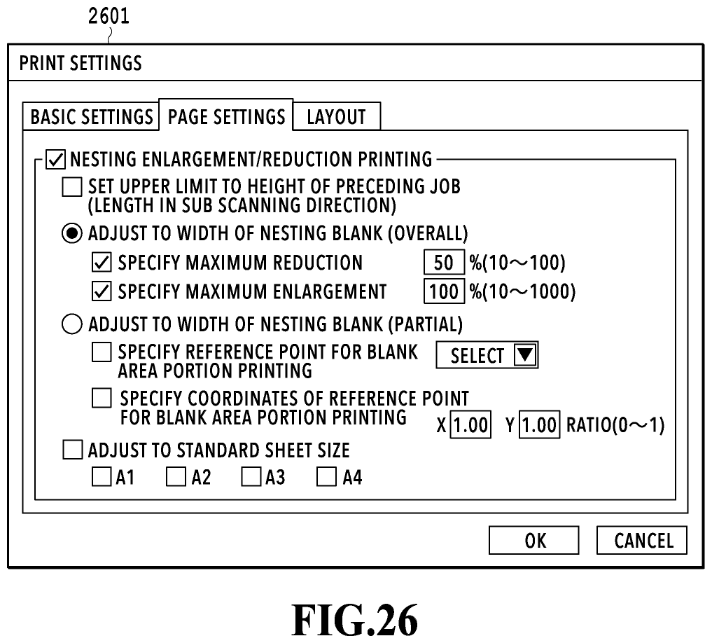

FIG. 26 is a schematic diagram illustrating a page setting screen 2601 indicating a nesting scaling print setting for the image 2501. Here, in the nesting scaling print setting, maximum reduction is specified to be 50%, and maximum enlargement is specified to be 100%. The image forming apparatus 100 stores the print job information received by the main controller 111 into a storage apparatus such as the RAM 114 or HDD 118 and analyzes the print job information to determine the placement position of the image.

In S401, the image placement unit 161 of the image generation unit 160 obtains the blank area size in the main scanning direction available for nesting printing, from the blank-area size information 707. The size of the nesting blank area is 0 mm in the main scanning direction and 429 mm in the sub scanning direction.

In S402, the image placement unit 161 calculates the maximum-reduction size to which reduction is permitted in the nesting-scaling-print setting information on the image 2501. Here, since the maximum-reduction size of the image 2501 is 50%, the maximum-reduction size is 78 mm in the main scanning direction and 156 mm in the sub scanning direction.

In S403, the image placement unit 161 calculates the maximum-enlargement size to which enlargement is permitted in the nesting-scaling-print setting information on the image 2501. Here, since the maximum-enlargement size of the image 2501 is 100%, the maximum-enlargement size is 156 mm in the main scanning direction and 312 mm in the sub scanning direction. The calculation results in S402 and S403 are held in the nesting-scaling image information 811.

In S404, the main controller 111 determines whether the maximum-reduction size of the image 2501 is within the blank area size. Regarding the size in the main scanning direction, since the blank area size, 0 mm, is smaller than the maximum-reduction size of the image 2501, 78 mm, the main controller 111 determines that the image 2501 cannot be placed within the blank.

In S410, the image placement unit 161 determines whether the preceding print jobs include scaling jobs. The image placement unit 161 refers to the nesting-scaling image information table illustrated in FIG. 8 and, in this case, determines that the preceding print jobs include scaling jobs because the print jobs corresponding to the nesting-scaling image information 809 and 810 are scaling jobs. The pieces of nesting-scaling image information 809 and 810 correspond to the image 901 placed in the area 1101 and the image 1801 placed in the area 2001, respectively, illustrated in FIG. 20. Note that in the case in which the preceding print jobs include no scaling job, placement of the image 2501 is canceled in S415. The print job information the placement of which is canceled is stored in a storage apparatus such as the RAM 114 or the HDD 118. The image of a print job that cannot be placed may be turned by 90 degrees, and whether it can be placed may be determined again as a general nesting function.

In S411, the image placement unit 161 calculates the sum of the maximum-reduction sizes of the image 901, the image 1801, and the image 2501 included in the scaling jobs. The maximum-reduction sizes of the image 901, the image 1801, the image 2501 are 196 mm, 137 mm, and 78 mm, respectively, according to the pieces of nesting-scaling image information 809 to 811. The sum of the maximum-reduction sizes of these three scaling jobs is calculated by adding the sum of the margin sizes between images, 20 mm, to the sum of the all of the maximum-reduction sizes, 411 mm, and the result is 431 mm.

In S412, the blank-area measurement unit 162 of the image generation unit 160 calculates the blank area size in the case in which only the images included in print jobs other than scaling jobs are placed. The image data of the print jobs other than scaling jobs corresponds to the nesting-scaling image information 808 according to the nesting-scaling image information table illustrated in FIG. 8, and the size of the image in the main scanning direction is 234 mm. The size of the nesting blank area in the main scanning direction in the case in which only the image included in the print job other than scaling jobs is placed is calculated by subtracting the above 234 mm and a margin size between images, 10 mm, from the blank area size of the roll paper 600 before image placement, 908 mm, and the result is 664 mm.

In S413, the image placement unit 161 determines whether the value of the sum of the maximum-reduction sizes of the scaling jobs in the main scanning direction is smaller than or equal to the size of the nesting blank area in the main scanning direction calculated in S412. In the case in which the sum of the maximum-reduction sizes of the scaling jobs in the main scanning direction is larger than the calculated size of the nesting blank area in the main scanning direction, the placement is canceled in S415. Since the sum of the maximum-reduction sizes of the scaling jobs in the main scanning direction, 431 mm, is smaller than or equal to the calculated size of the nesting blank area in the main scanning direction, 664 mm, the image placement unit 161 determines that the three images can be placed in the nesting blank area.

In S414, the image placement unit 161 determines to place the images included in the scaling jobs in the nesting blank area according to a size adjustment method selected in the setting screen 301 illustrated in FIG. 3A by using the scaling processing unit 171 of the size adjustment unit 170. In the case of a precedence priority setting, size reduction is started from an image placed later, in other words, an image the placement order of which is later such that it can be within the nesting blank area. Regarding the image 2501 which is the last to be placed, the size of the image in the main scanning direction is reduced to the maximum-reduction size, 78 mm. The size of the image 1801 is reduced to 175 mm, and the size of the image 901 is not changed. Then, all of the images are placed. In the case of an equal width setting in the main scanning direction, the widths in the main scanning direction are set to be equal. The sizes of the images 901, 1801, and 2501 in the main scanning direction are reduced to 214 mm, and all of the images are then placed. In the case of an equal ratio setting in the main scanning direction, the resizing ratios in the main scanning direction are set to be equal. To reduce the sum of the sizes of the images 901, 1801, and 2501 in the main scanning direction, 820 mm, to 644 mm, which is a subtraction value of the margin sizes between images, 20 mm, from 664 mm, each size needs to be multiplied by 0.78. Hence, the sizes of the three images 901, 1801, and 2501 in the main scanning direction are multiplied by 0.78 and thereby reduced to 307 mm, 214 mm, and 122 mm, and all of the images are placed.

In S408, the image placement unit 161 generates images by specifying the sizes after placement is determined to the image processing unit 116 for the images the sizes of which need to be adjusted, and stores the images in a storage apparatus such as the RAM 114 or the HDD 118.

In S409, the blank-area measurement unit 162 of the image generation unit 160 calculates the nesting blank area size in the same manner as described above.

Since scaling permission according to the purpose of printing is given to each print job as described above, it is possible to obtain print images for nesting printing in which printing is performed without degrading sheet efficiency with images arranged in the main scanning direction. In the case of printing for checking finish, giving reduction permissions increases the possibility of obtaining print images in nesting printing. In the case of printing for checking fine details of letters or the like by enlarging them, giving enlargement permissions increases the possibility of obtaining large images for checking by utilizing blank areas.

Although the description of the above embodiment is based on a case in which images are arranged in the main scanning direction (sheet width direction) on roll paper, the present disclosure is also applicable to cut sheets, which are sheets having standard uniform sheet sizes, and is capable of providing the same or similar effects also in this case.

Regarding cut sheets, by replacing the main scanning direction with the sub scanning direction and replacing the sub scanning direction with the main scanning direction in the above description, the present disclosure can be applied to also cases in which images are arranged in the sub scanning direction.

### OTHER EMBODIMENTS

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the disclosure is not limited to the disclosed exemplary embodiments. The scope of the following claims should be accorded the broadest interpretation so as to encompass all such modifications and equivalent structures and functions.

The present disclosure is capable of improving sheet efficiency in printing with a plurality of images arranged on a sheet.

This application claims the benefit of Japanese Patent Application No. 2022-189955, filed Nov. 29, 2022, which is hereby incorporated by reference wherein in its entirety.

1. An image processing apparatus comprising:
a generation unit that generates image data for printing in which a plurality of images included in a plurality of print jobs are arranged in a print area of a sheet; and
a size adjustment unit that performs size adjustment on an image to be placed in the print area, wherein
in a case in which the generation unit generates the image data for printing in which the plurality of images are arranged in order in a specified direction, the size adjustment unit performs the size adjustment on an image to be placed such that the size of the image to be placed is within the size of a blank area located in the specified direction relative to an image placed immediately beforehand.

2. The image processing apparatus according to claim 1, wherein
the sheet is roll paper, and
the specified direction is perpendicular to a conveyance direction of the sheet.

3. The image processing apparatus according to claim 1, wherein
the size adjustment is resizing an image or cutting out part of an image.

4. The image processing apparatus according to claim 1, further comprising
a setting unit with which a size adjustment range is set for each of the images, wherein
the size adjustment unit performs the size adjustment on the plurality of images within the size adjustment ranges.

5. The image processing apparatus according to claim 4, wherein
the size adjustment range is specified out of standard sheet sizes of the sheet.

6. The image processing apparatus according to claim 1, wherein
the size adjustment unit includes a calculation unit that calculates the size of the blank area in the print area by using the size of the print area and the sizes of the images placed in the print area, and
the size adjustment unit performs the size adjustment according to the size of the blank area calculated by the calculation unit.

7. The image processing apparatus according to claim 1, wherein
in a case in which even if the size adjustment is performed on the image to be placed, the size of the image to be placed subjected to the size adjustment is not within the size of the blank area, the size adjustment unit performs the size adjustment on an image placed in the print area such that the size of the image to be placed is within the size of the blank area.

8. The image processing apparatus according to claim 7, wherein
the size adjustment unit performs the size adjustment according to one of a precedence priority setting in which the size adjustment is performed in order from an image placed later out of the images placed in the print area, an equal width setting in which lengths in the specified direction of the images placed in the print area are set equal to one another, and an equal ratio setting in which resizing ratios in the specified direction of the images placed in the print area are set equal to one another.

9. An image forming apparatus comprising:
a reception unit that receives a print job;
a generation unit that generates image data for printing in which a plurality of images included in a plurality of print jobs are arranged in a print area of a sheet;
a size adjustment unit that performs size adjustment on an image to be placed in the print area; and
a print unit that prints images based on the image data for printing onto the sheet, wherein
in a case in which the generation unit generates the image data for printing in which the plurality of images are arranged in order in a specified direction, the size adjustment unit performs the size adjustment on an image to be placed such that the size of the image to be placed is within the size of a blank area located in the specified direction relative to an image placed immediately beforehand.

10. An image processing method comprising:
generating image data for printing in which a plurality of images included in a plurality of print jobs are arranged in a print area of a sheet; and
adjusting a size of an image to be placed in the print area, wherein
in a case in which the generating generates the image data for printing in which the plurality of images are arranged in order in a specified direction, the adjusting adjusts the size of an image to be placed such that the size of the image to be placed is within the size of a blank area located in the specified direction relative to an image placed immediately beforehand.

11. A non-transitory computer readable storage medium storing a program that causes a computer to execute an image processing method comprising:
generating image data for printing in which a plurality of images included in a plurality of print jobs are arranged in a print area of a sheet; and
adjusting a size of an image to be placed in the print area, wherein
in a case in which the generating generates the image data for printing in which the plurality of images are arranged in order in a specified direction, the adjusting adjusts the size of an image to be placed such that the size of the image to be placed is within the size of a blank area located in the specified direction relative to an image placed immediately beforehand.
